(19) United States
(12) Patent Application Publication
(10) Pub. No.: US 2019/0348795 A1
(43) Pub. Date: Nov. 14, 2019

(54) COVER FOR CABLE CONNECTOR

(71) Applicant: Hubbell Incorporated, Shelton, CT (US)

(72) Inventors: Matthew Bullard, Unionville, CT (US); Thomas Scanzillo, Monroe, CT (US)

(21) Appl. No.: 16/475,953

(22) PCT Filed: Jan. 9, 2018
(86) PCT No.: PCT/US18/12945

§ 371 Date: Jul. 3, 2019

Related U.S. Application Data
(60) Provisional application No. 62/444,047, filed on Jan. 9, 2017.

(51) Int. Cl. H01R 13/52; H01R 43/20

(52) U.S. Cl. CPC H01R 13/5213; H01R 43/20; H01R 13/5219; H01R 13/5205

(57) ABSTRACT

A cable connector includes a housing, a cable, and a cover. The housing includes an end and an opening positioned adjacent the end. The cable includes a conducting end secured within the opening and in electrical communication with the housing. The cover includes an aperture substantially aligned with the opening of the housing. The cable passes through the aperture. The cover extends over at least a portion of the housing and a portion of the cable positioned adjacent the end of the housing. The cover forms a fluid-tight seal around the portion of the housing and the portion of the cable.

### CROSS-REFERENCE TO RELATED APPLICATION

This application claims the benefit of co-pending, prior-filed U.S. Provisional Patent Application No. 62/444,047, filed Jan. 9, 2017, the entire contents of which are hereby incorporated by reference.

### BACKGROUND

The present disclosure relates to cable connectors, and particularly to protective coverings for cable connectors.

Electrical and communication cable connectors may be used in a variety of environments. In some circumstances, the connectors are used in an environment that may be washed periodically (e.g., with a water or other fluid-spraying hose), such as in locations that relate to food and beverage service and preparation. In some cases, the connectors contain small cracks or spaces into which dirt or other contaminants may accumulate.

### SUMMARY

In one aspect, a cable connector includes a housing, a cable, and a cover. The housing includes an end and an opening positioned adjacent the end. The cable includes a conducting end secured within the opening and in electrical communication with the housing. The cover includes an aperture substantially aligned with the opening of the housing. The cable passes through the aperture. The cover extends over at least a portion of the housing and a portion of the cable positioned adjacent the end of the housing. The cover forms a fluid-tight seal around the portion of the housing and the portion of the cable.

In another aspect, a connector assembly includes a first connector, a second connector, and at least one cover. The first connector includes a first housing and a first cable. The first housing includes a first end, a second end, and an opening positioned adjacent the first end. The first cable includes a conducting end secured within the opening and in electrical communication with the first housing. The second connector includes a second housing and a second cable. The second housing includes a first end, a second end, and an opening positioned adjacent the first end. The second end of the second housing engages the second end of the first housing to form electrical connection between the first connector and the second connector. The second cable includes a conducting end secured within the opening and in electrical communication with the second housing. The at least one cover includes an aperture, and each cover extends over a portion of one of the first housing and the second housing. The aperture is substantially aligned with the opening of the one of the first housing and the second housing. The cover forms a fluid-tight seal around the portion of the one of the first housing and the second housing.

In yet another aspect, a method of coupling a cable to a housing includes: positioning a cover adjacent an end of the housing such that an aperture in the cover is substantially aligned with an opening of the housing; extending a portion of the cover over at least a portion of the housing proximate the end of the housing, the cover in fluid-tight relationship with the housing; inserting a conducting end of a cable through the aperture of the cover; and inserting the conducting end of the cable into the opening of the housing.

The above-described and other features and advantages of the present disclosure will be appreciated and understood by those skilled in the art from the following detailed description and drawings.

### BRIEF DESCRIPTION OF THE DRAWINGS

FIG. 1 is an exploded view of a cable connector assembly.

FIG. 2 is a perspective view of the cable connector assembly of FIG. 1, with a cover in a collapsed state.

FIG. 3 is a perspective view of the cable connector assembly of FIG. 3, with the cover positioned over a portion of a housing after a cable has been inserted into the housing.

FIG. 4 is a perspective view of a cable connector assembly of FIG. 3, with the cover positioned over a portion of the housing before a cable has been inserted into the housing.

FIG. 5 is a cross-section view of the cable connector assembly of FIG. 3, viewed along section 5-5.

FIG. 6 is a perspective view of a pair of cable connectors in a disconnected state.

FIG. 7 is a perspective view of a pair of cable connectors in a connected state.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

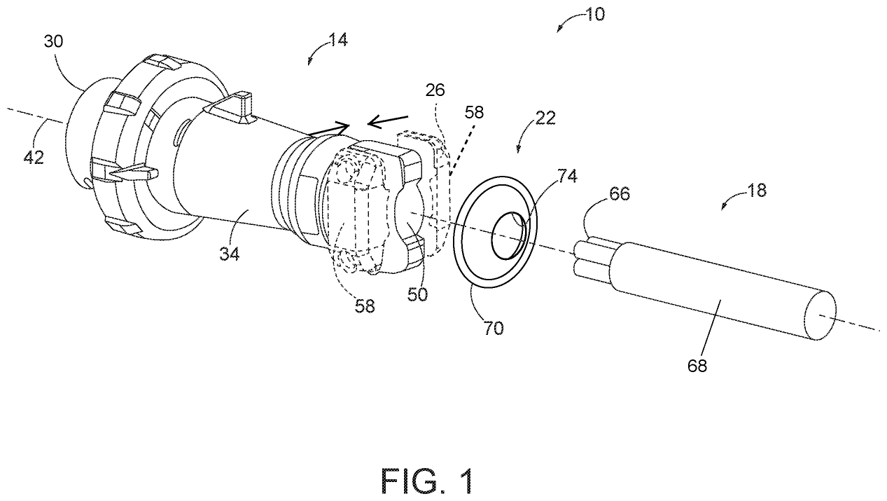

FIG. 1 illustrates a cable connector assembly 10 according to one embodiment. The cable connector assembly 10 includes a connector housing 14, a cable 18, and a protective cover 22. In the illustrated embodiment, the connector housing 14 includes a first end 26, a second end 30, and a body portion 34 extending between the first end 26 and the second end 30 along a housing axis 42. In the illustrated embodiment, parts of the body portion 34 have a substantially cylindrical or frustoconical shape. A pair of contacts 58 is positioned on the first end 26, with one contact on each side of an opening 50. Each of the contacts 58 is biased inwardly toward the opening 50. In the illustrated embodiments, an outer surface of each contact 58 protrudes radially outwardly from the housing axis 42. The first end 26 may form a strain relief portion of the housing 14.

The cable 18 includes a conducting end 66 that is positioned within the opening 50. In the illustrated embodiment, the cable 18 may be substantially covered by a sheath 68, except for the conducting end 66. The contacts 58 are biased to engage and make electrical contact with the conducting end 66, thereby clamping onto the cable 18 and securing it relative to the housing 14. The contacts 58 provide electrical communication through the housing 14, from the conducting end 66 to another connector adjacent the second end 30 of the housing 14 (described below).

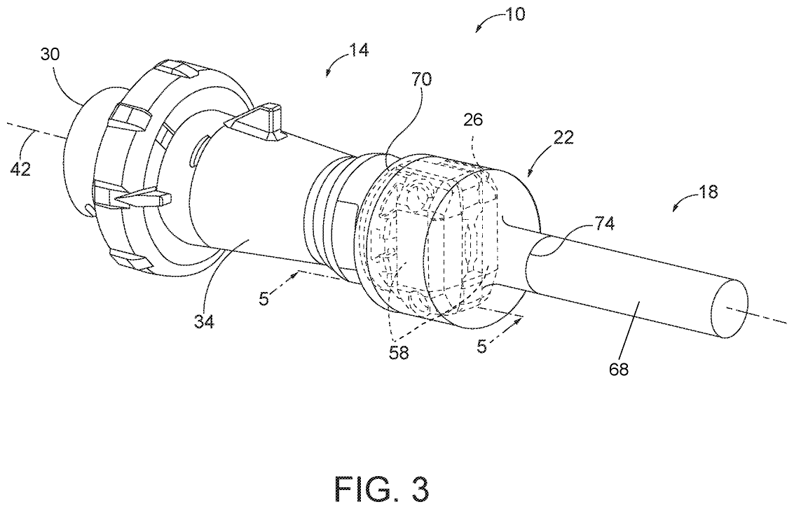

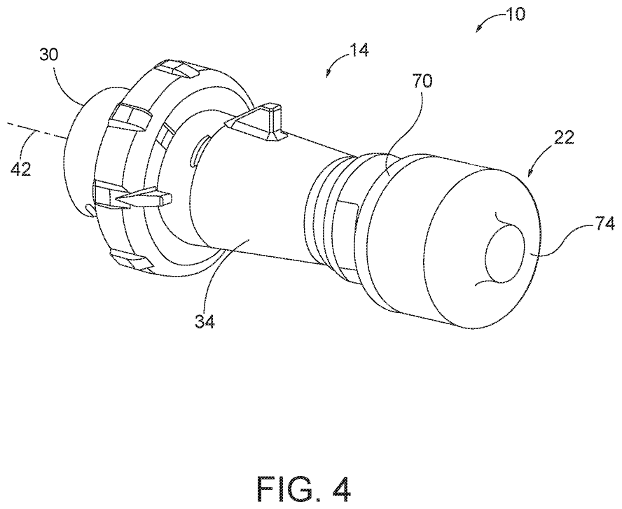

The cover 22 can be formed from a thin membrane material (e.g., latex, nitrile). In the illustrated embodiment, the cover 22 is formed in a substantially cylindrical shape. In an initial or collapsed condition (FIG. 1), the cover 22 is substantially flat with a rolled portion 70 forming a perimeter. When the cover 22 is deployed (FIGS. 3 and 4), the outer perimeter is unrolled to provide one end that is open and an opposite end that is partially enclosed. The cover 22 includes an aperture 74 formed in the partially enclosed end.

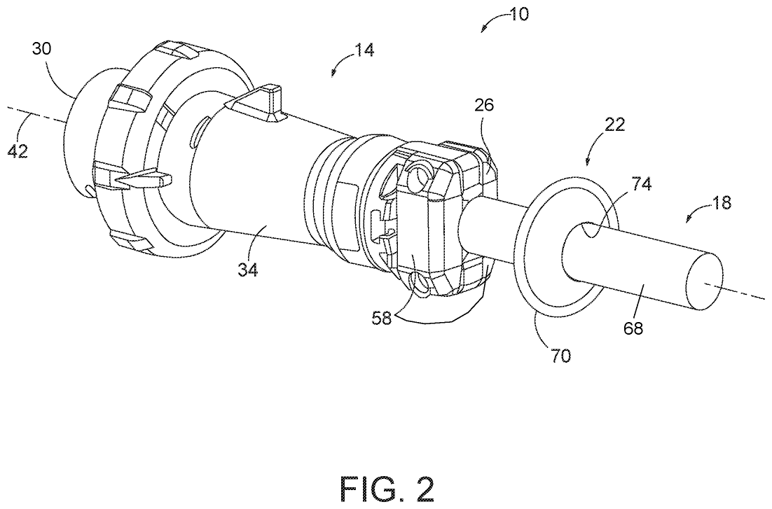

FIGS. 2 and 3 illustrate one method of assembly in which the cover 22 is initially positioned adjacent the first end 26 of the housing 14, and the aperture 74 of the cover 22 is substantially aligned with the opening 50 of the housing 14. The conducting end 66 is inserted through the aperture 74 (FIG. 2) and is secured within the opening 50 of the housing 14. As shown in FIG. 3, the rolled portion of the cover 22 is then unrolled and/or stretched over the first end 26 of the housing 14. In the illustrated embodiment, the cover 22 is unrolled over the outer surface of the contacts 58; in other embodiments, the cover 22 may be unrolled over a larger portion of the housing 14, and may be unrolled over the entire housing 14.

Referring to FIG. 4, in another method of assembling the connector, the cover 22 may be unrolled or stretched over the first end 26 of the housing 14 before the cable 18 is inserted into the opening 50. The cover 22 is unrolled while maintaining the aperture 74 substantially aligned with the opening 50. After the cover 22 is in place, the conducting end 66 of the cable 18 may be first through the aperture 74 of the cover 22 and into the opening 50 of the housing 14.

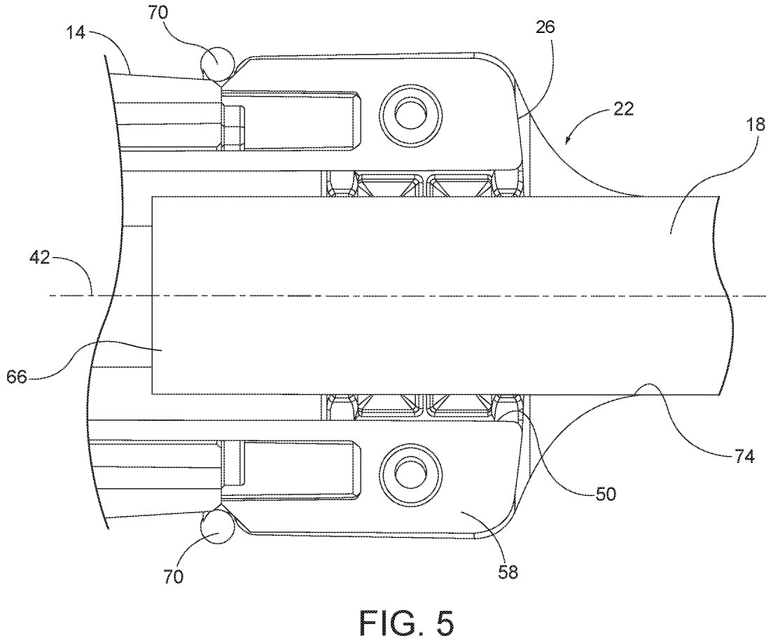

As shown in FIG. 5, a remainder of the rolled portion 70 of the cover 22 may be positioned on an opposite side of the contacts 58 from the opening 50. The remainder of the rolled portion 70 exerts a compressive force against the outer surface of the housing 14 along the perimeter of the cover 22, thereby assisting in securing the cover 22 against movement relative to the housing 14 and facilitating a fluid-tight seal.

The cover 22 provides a cone seal over at least the first end 26 of the housing 14 and around the connection between the cable 18 and the housing 14. Fluids (e.g., water) run off the surface of the cover 22 and away from the housing 14 and cable 18. The cover 22 thereby prevents the accumulation and penetration of dirt and other contaminants within the housing 14, even in environments that are frequently subject to being sprayed by pressurized fluids.

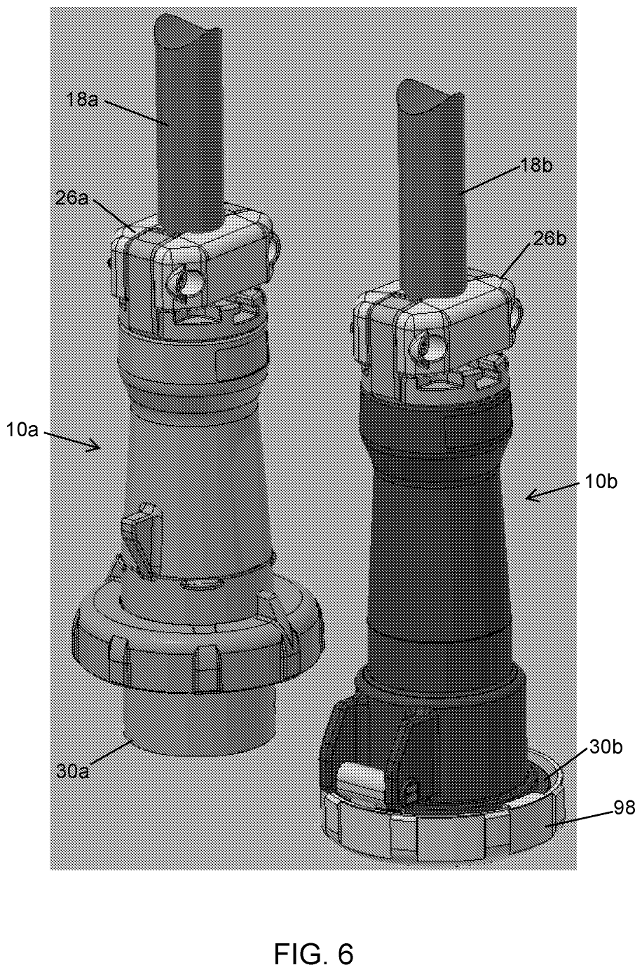

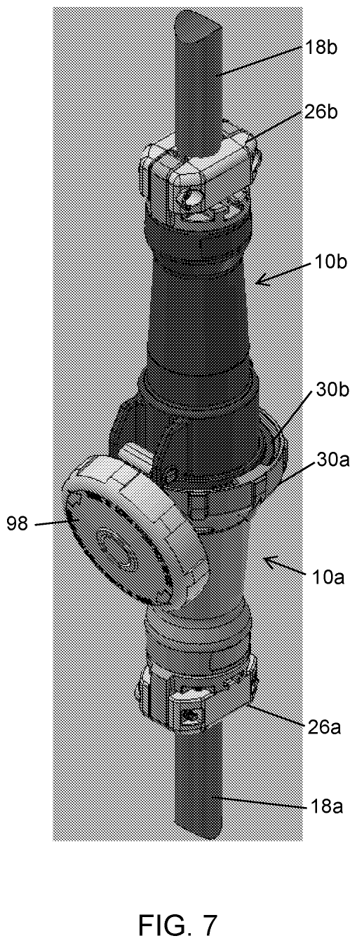

FIGS. 6 and 7 illustrate a pair of connector assemblies 10a, 10b. The connector assemblies 10a, 10b are substantially similar to the connector 10 shown and described above with respect to FIGS. 1-5, although a second end 30a of the connector assembly 10a is a male connector or plug, while the second end 30b of the connector assembly 10b is a female connector or receptacle. In the illustrated embodiment, the connector assembly 10b includes a flange 98 that is pivotably coupled to the second end 30b to provide access to the receptacle. As shown in FIG. 7, the second end 30a of the connector assembly 10a may be inserted to engage the second end 30b of the connector assembly 10b. Although the cover 22 is not shown in FIGS. 6 and 7, it is understood that the first ends 26a, 26b of the connectors 10a, 10b may each include a cover 22 as shown and described above.

The embodiments described above and illustrated in the figures are presented by way of example only and are not intended as a limitation upon the concepts and principles presented herein. As such, it will be appreciated that variations and modifications exist within the scope and spirit of one or more independent aspects as described.

What is claimed is:

1. A cable connector comprising:
a housing including an end and an opening positioned adjacent the end;
a cable including a conducting end secured within the opening and in electrical communication with the housing; and
a cover including an aperture substantially aligned with the opening of the housing, the cable passing through the aperture, the cover extending over at least a portion of the housing and a portion of the cable positioned adjacent the end of the housing, the cover forming a fluid-tight seal around the portion of the housing and the portion of the cable.

2. The cable connector of claim 1, wherein the opening of the housing extends along an axis, the housing including an outer surface having a portion protruding radially away from the axis, wherein the cover extends over the radially protruding portion of the outer surface such that an end of the cover is positioned on an opposite side of the radially protruding portion from the aperture of the cover.

3. The cable connector of claim 1, wherein the cover includes a first end and a second end opposite the first end, the first end being open and the second end including the aperture, the cover being capable of rolling the first end toward the second end, a rolled portion of the cover being positioned along a perimeter of the cover.

4. The cable connector of claim 3, wherein a rolled portion of the cover exerts a compressive force against an outer surface of the housing.

5. The cable connector of claim 1, wherein the aperture forms a fluid-tight engagement with an outer surface of the cable.

6. The cable connector of claim 1, wherein the end of the housing is a first end, the housing further including a second end configured to engage an end of another connector.

7. The cable connector of claim 1, wherein the end of the housing includes at least one contact biased toward the opening to engage the conducting end of the cable and provide an electrical connection between the housing and the conducting end.

8. A connector assembly comprising:
a first connector including,
a first housing including a first end, a second end, and an opening positioned adjacent the first end, and
a first cable including a conducting end secured within the opening and in electrical communication with the first housing;
a second connector including,
a second housing including a first end, a second end, and an opening positioned adjacent the first end, the second end of the second housing engaging the second end of the first housing to form electrical connection between the first connector and the second connector, and
a second cable including a conducting end secured within the opening and in electrical communication with the second housing; and
at least one cover including an aperture, each cover extending over a portion of one of the first housing and the second housing, the aperture substantially aligned with the opening of the one of the first housing and the second housing, the cover forming a fluid-tight seal around the portion of the one of the first housing and the second housing.

9. The connector assembly of claim 8, wherein the opening of the first housing extends along an axis, a portion of the first housing proximate the first end including an outer surface protruding radially away from the axis, wherein the cover extends over the radially protruding portion such that an end of the cover is positioned on an opposite side of the radially protruding portion from the aperture of the cover.

10. The connector assembly of claim 8, wherein the cover includes a first end and a second end opposite the first end, the first end being open and the second end including the aperture, the cover being capable of rolling the first end toward the second end, a rolled portion of the cover being positioned along a perimeter of the cover.

11. The connector assembly of claim 10, wherein a rolled portion of the cover exerts a compressive force against an outer surface of the one of the first housing and the second housing.

12. The connector assembly of claim 8, wherein the aperture forms a fluid-tight engagement with an outer surface of one of the first cable and the second cable.

13. The connector assembly of claim 8, wherein the second end of the first housing includes a plug, and wherein the second end of the second housing includes a receptacle for receiving the plug.

14. The connector assembly of claim 8, wherein the first end of the first housing includes at least one contact biased toward the opening to engage the conducting end of the first cable and provide an electrical connection between the first housing and the first conducting end.

15. A method of coupling a cable to a housing, the method comprising:
positioning a cover adjacent an end of the housing such that an aperture in the cover is substantially aligned with an opening of the housing;
extending a portion of the cover over at least a portion of the housing proximate the end of the housing, the cover in fluid-tight relationship with the housing;
inserting a conducting end of a cable through the aperture of the cover; and
inserting the conducting end of the cable into the opening of the housing.

16. The method of claim 15, wherein extending a portion of the cover includes unrolling at least a portion of a rolled peripheral portion of the cover over an outer surface of the oirtuib if tge housing.

17. The method of claim 15, wherein inserting the conducting end of the cable into the opening of the housing occurs after extending the portion of the cover over at least a portion of the housing.

18. The method of claim 15, wherein inserting the conducting end of the cable into the opening of the housing occurs before extending the portion of the cover over at least a portion of the housing.

19. The method of claim 15, wherein inserting the conducting end of the cable provides a fluid-tight seal between the cover and an outer surface of the cable.

20. The method of claim 15, wherein extending the portion of the cover includes a rolled peripheral portion of the cover exerting a compressive force against an outer surface of the housing.
